(19) United States
(12) Patent Application Publication
(10) Pub. No.: US 2015/0237898 A1
(43) Pub. Date: Aug. 27, 2015

(54) STEVIOSIDE BLENDS

(71) Applicant: Cargill, Incorporated, Wayzata, MN (US)

(72) Inventors: Ting Lui Carlson, Marietta, SC (US); Wade N. Schmelzer, St. Louis Park, MN (US); Christopher Austin Tyler, Minnetonka, MN (US); Brian D. Guthrie, Chanhassen, MN (US); Timothy Andrew Lindgren, Crystal, MN (US); Michael Alan Mortenson, Rogers, MN (US)

(73) Assignee: Cargill, Incorporated, Wayzata, MN (US)

(21) Appl. No.: 14/431,037

(22) PCT Filed: Sep. 25, 2013
(86) PCT No.: PCT/US13/61685

§ 371 Date: Mar. 25, 2015

Related U.S. Application Data
(60) Provisional application No. 61/705,471, filed on Sep. 25, 2012.
(60) Provisional application No. 61/714,893, filed on Oct. 17, 2012.

(51) Int. Cl. A23L 1/22

(52) U.S. Cl. CPC A23L 1/22; A23V 2002/00

(57) ABSTRACT

Sweetener compositions comprising particular glycoside blends are described in this paper. The glycoside blends comprise any or all of rebaudioside A, rebaudioside B, and rebaudioside D together with stevioside in various proportions. The sweetener composition can also include one or more bulking agents or other ingredients. The sweetener compositions can be used in foods and beverages.

### CROSS REFERENCE TO RELATED APPLICATION

This application claims the benefit of the U.S. Provisional Patent Application, Ser. No. 61/705,471, filed Sep. 25, 2012, STEVIOSIDE BLENDS, and to U.S. Provisional Patent Application, Ser. No. 61/714,893, filed Oct. 17, 2012, STEVIOSIDE BLENDS, which is hereby incorporated by reference in its entirety.

### FIELD OF THE DISCLOSURE

The present disclosure relates to sweetener compositions comprising stevioside blends. The sweetener compositions of the present disclosure can further comprise other ingredients, such as one or more bulking agents. The present disclosure also relates to incorporation of the sweetener compositions into foods and/or beverages.

### BACKGROUND

The species Stevia rebaudiana (“stevia”) has been the subject of considerable research and development efforts directed at the purification of certain naturally occurring sweet glycosides of stevia that have potential as non-caloric sweeteners. Sweet glycosides that may be extracted from stevia include the six rebaudiosides (i.e., rebaudioside A to F), stevioside, rubusoside, steviolbioside, and dulcoside A.

### SUMMARY

The present disclosure relates to sweetener compositions that are blends of stevioside and other steviol glycosides. The sweetener compositions of the present disclosure can also include other ingredients such as bulking agents, flavorings, other high intensity sweeteners, or the like. The present disclosure also pertains to the use of the sweetener compositions in foods and beverages.

Certain glycosides combined with stevioside result in blends which have higher effective sweetening power than rebaudioside A (Reb A). Additionally, some blends have lower bitterness (while attaining the same or higher sweetness) than Reb A. Some blends have faster sweetness onset and/or less linger than Reb A. Yet other blends may have a taste which is more pleasing than Reb A. These blends of glycosides include, for example, Reb A, rebaudioside B (Reb B) and/or rebaudioside D (Reb D) with stevioside.

Higher effective sweetening power can mean that a certain sucrose equivalent value (SEV) can be achieved by a particular blend at a lower concentration than Reb A. Alternately, higher effective sweetening power can mean that a blend has greater potency than Reb A—that is, at equivalent concentration, the blend shows a higher SEV than Reb A. Higher effective sweetening power may also mean that a particular blend has a faster sweetness onset than Reb A. A blend having higher effective sweetening power may be described herein as having higher sweetness, increased sweetness, or the like when compared to Reb A or other glycosides.

For these blends, the reduction in concentration of glycoside needed to achieve a certain level of sweetness can result in ample savings by allowing the utilization of lower amounts of the glycoside in sweetener compositions yet achieving the same level of sweetness. Additionally, lower levels of bitterness could allow for easier incorporation into certain foods and beverages.

In certain preferred embodiments, the blends are high purity glycoside blends. In other preferred embodiments, the glycoside blends provide a relatively high sucrose equivalent value (“SEV”) in the sweetener compositions. In these embodiments, when a higher level of sweetness is needed in sweetener compositions for certain food or beverage applications, the substantial benefit that the glycoside blends provide could better be realized.

In one particular embodiment, a blend comprising 2% to 15% Reb A, 2% to 8% Reb B, 20% to 65% Reb D, and 30% to 75% stevioside, is provided. This blend may be sweeter than Reb A. Additionally or alternatively, this blend may have a faster sweetness onset and/or less linger than Reb A.

In another particular embodiment, a blend comprising 5% to 20% Reb A, 20% to 70% Reb B, 5% to 20% Reb D, and 20% to 65% stevioside is provided. This blend may be less bitter than Reb A. Additionally or alternatively, this blend may have a shorter bitter aftertaste than Reb A.

In another particular embodiment, a blend comprising 2% to 15% Reb A, 15% to 35% Reb B, 25% to 45% Reb D, and 30% to 50% stevioside, is provided, with the amount of Reb A and stevioside no more than 60% of the amount of Reb A, Reb B, Reb D and stevioside in the blend. In some aspects, the amount of Reb A and stevioside is no more than 50% of the blend. This blend may be sweeter than Reb A, and/or less bitter than Reb A.

In yet another particular embodiment, a blend comprising Reb A, 10% to 40% Reb B, 20% to 50% Reb D, and 25% to 55% stevioside is provided, with the amount of Reb A and stevioside no more than 60% of the amount of Reb A, Reb B, Reb D and stevioside in the blend. In some aspects, the amount of Reb A and stevioside is no more than 50% of the blend. This blend may be sweeter than Reb A, and/or less bitter than Reb A.

In yet another particular embodiment, a blend comprising 25% to 45% Reb A, 25% to 45% Reb B, 5% to 25% Reb D, and 5% to 25% stevioside is provided. This blend may be 30% to 40% Reb A, 30% to 40% Reb B, 10% to 20% Reb D, and 10% to 20% stevioside. For example, this blend may be 40% Reb A, 40% Reb B, 10% Reb D, and 10% stevioside, or, 30% Reb A, 30% Reb B, 20% Reb D, and 20% stevioside.

In some embodiments, the blends of this disclosure provide an SEV of greater than 5, greater than 6, greater than 7, greater than 8, greater than 9, or greater than 10.

In another embodiment, sweetener compositions made with blends of this disclosure are provided. The sweetener compositions comprise any blend of this disclosure and a bulking agent. In other embodiments, the blends of the present invention can be utilized as flavor modifiers.

These and other objects, features, and advantages of the invention will be apparent from the following detailed description and claims.

### DETAILED DESCRIPTION

As described above, there are a number of glycosides present in the stevia plant. At present, the major sweet constituents in typical stevia plants are Reb A and stevioside. A number of studies have been conducted on the sweetness and bitterness of the glycosides, and of Reb A and stevioside in particular. One study has shown that Reb A has the highest sweetening power of all the glycosides, and in particular has a higher sweetening power than stevioside. (See Puri, M., Sharma, D., Tiwari, A. K., Biotechnology Advances 29, 2011, 781-791). Another study indicates that Reb A is more potent and more pleasant tasting than stevioside. (See Jenner, M. R., 1989, Progress in Sweeteners. In: Grenby, T. (Ed.). Elsevier, London, pp 121-141). Yet another study shows that stevioside is more bitter than Reb A. (See Hellfritsch, C., Brockhoff, A., Stahler, F., Meyerhof, W., Hofmann, T., Human Psychometric and Taste Responses to Steviol Glycosides, J. Agric, Food Chem, May 2012, 60, 6782-6793).

Thus, it is well appreciated that stevioside possesses characteristics that, when compared to other glycosides, particularly Reb A, are undesirable for sweeteners. In particular, stevioside is known to be much less sweet and much more bitter than Reb A and other glycosides. Because stevioside, itself, does not have a desirable taste, in general, stevia products seek to minimize stevioside in stevia sweetener compositions. Most available stevia products are based on Reb A, with minor amounts of other glycosides, based on extensive purification processes from the stevia plant. Stevioside is usually left in the byproduct stream from the process and is used for lower grade food or feed applications.

Applicants, however, have discovered that certain blends that include stevioside have surprising characteristics such as low bitterness, low licorice taste, and/or increased sweetness, in particular when compared to Reb A. Such a discovery is truly unexpected when one considers stevioside's known characteristics.

Thus, in certain embodiments, the blends of this disclosure provide increased sweetness compared to Reb A having a high level of purity (i.e. at least 60% pure, in some embodiments at least 80% pure, in other embodiments at least 90% pure, in yet other embodiments, at least 95% pure). Additionally, or alternatively, certain blends of this disclosure provide decreased bitterness compared to Reb A. Additionally, or alternatively, certain blends of this disclosure provide an onset of sweetness (to the taster) that is faster than Reb A. Additionally, or alternatively, certain blends of this disclosure provide decreased licorice taste compared to Reb A. Additionally, or alternatively, certain blends of this disclosure provide less linger than Reb A. Additionally, or alternatively, certain blends of this disclosure provide a more sucrose like taste than Reb A. Additionally, or alternatively, certain blends of this disclosure provide a more pleasing taste than Reb A. The certain stevioside blends described herein may show these or other taste benefits when compared to Reb A particularly, or other glycosides.

The term “glycoside blend” as used herein means a blend of the various glycosides obtained from the stevia plant. These glycosides include, but are not limited to, rebaudiosides A-F, stevioside, dulcoside, steviobioside, and rubusoside. In particular, the glycoside blends of the present disclosure include blends consisting predominantly of any or all of Reb A, Reb B, Reb D, and stevioside. The term “stevioside blend” refers to a glycoside blend which includes stevioside. The terms glycoside blend and stevioside blend may be used interchangeably for blends which include stevioside.

The term “REB-ABDS glycoside blend” and variations thereof, as used herein, refers to a glycoside blend in which the primary components of the glycoside blend are Reb A, Reb B, Reb D and stevioside (hence, the “ABDS”). Other blends (e.g., Reb A, Reb D and stevioside; Reb B, Reb D and stevioside; etc.) may likewise be referred to in a similar manner. In a REB-ABDS glycoside blend, the combination of Reb A, Reb B, Reb D and stevioside will make up at least 85% of the total glycosides in the glycoside blend.

Reb A is a compound having the following chemical structure:

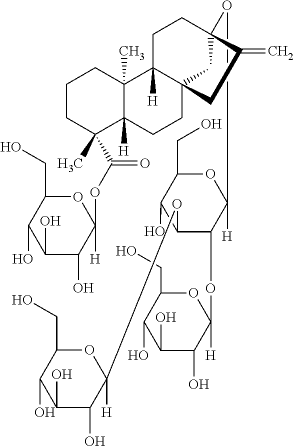

Reb B is a compound having the following chemical structure:

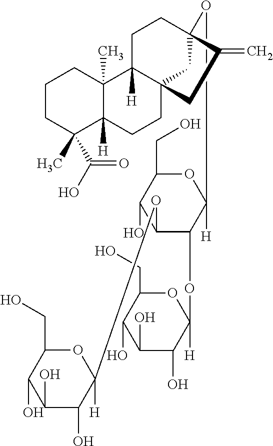

Reb D is a compound having the following chemical structure:

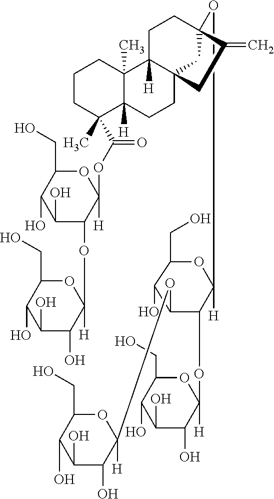

Stevioside is a compound having the following chemical structure:

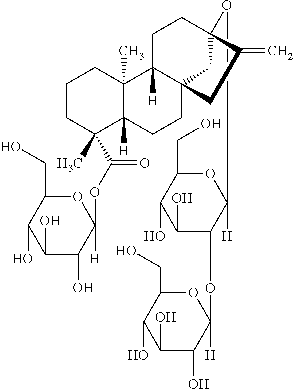

The blends, in addition to the stevioside and Reb A, Reb B and/or Reb D, optionally include one or more other glycosides from the stevia plant, such as rebaudioside C (dulcoside B), rebaudioside E, rebaudioside F, dulcoside A and rubusoside. The blends include no more than 15% of these optional glycosides. In some embodiments, the blends typically include no more than about 10% of these other glycosides. In other embodiments, the blends typically include no more than about 5% of these other glycosides and in yet other embodiments, no more than about 2% of the glycosides other than Reb A, Reb B, Reb D and stevioside.

In some embodiments, an REB-ABDS blend comprises, by weight, at least 2% yet no more than 15% Reb A, at least 2% yet no more than 8% Reb B, at least 20% yet no more than 65% Reb D, and/or at least 30% yet no more than 75% stevioside (based on the amount of Reb A, Reb B, Reb D and stevioside in the blend). This broad range of blends, and those blends that are within the parameter of this range, have an unexpectedly high level of sweetness due to the high level of stevioside in the blend. In some embodiments, the REB-ABDS blend comprises at least 3% Reb A, at least 2% Reb B, at least 40% Reb D, and/or at least 35% stevioside (based on the amount of Reb A, Reb B, Reb D and stevioside in the blend). Alternately in some embodiments, the REB-ABDS blend comprises at least 4% Reb A, at least 2% Reb B, at least 45% Reb D, and/or at least 40% stevioside (based on the amount of Reb A, Reb B, Reb D and stevioside in the blend). In some embodiments, the REB-ABDS blend comprises no more than 10% Reb A, no more than 6% Reb B, no more than 60% Reb D, and/or no more than 55% stevioside (based on the amount of Reb A, Reb B, Reb D and stevioside in the blend). Alternately in some embodiments, the REB-ABDS blend comprises no more than 8% Reb A, no more than 6% Reb B, no more than 55% Reb D, and/or no more than 45% stevioside (based on the amount of Reb A, Reb B, Reb D and stevioside in the blend).

Surprisingly, these blends have a high level of sweetness, even with the high level of stevioside in the blend. In some embodiments, these blends provide an SEV of greater than 5 when present in a sweetener composition, in other embodiments these blends provide an SEV of greater than 6 when present in a sweetener composition, in still other embodiments these blends provide an SEV of greater than 7 when present in a sweetener composition, in still other embodiments these blends provide an SEV of greater than 8 when present in a sweetener composition, in still other embodiments these blends provide an SEV of greater than 9 when present in a sweetener composition, and in still other embodiments these blends provide an SEV of greater than 10 when present in a sweetener composition.

Specific examples of blends that have an unexpectedly high level of sweetness even with the high level of stevioside in the blend are provided in Table 1.

TABLE 1
High % stevioside, unexpected sweetness

| Blend | Reb A | Reb B | Reb D | Stev |
|---|---|---|---|---|
| 1A | 0-25% | 0-25% | 20-75% | 30-75% |
| 1B | 5-25% | 0-20% | 20-75% | 30-75% |
| 1C | 0-15% | 0-10% | 40-65% | 30-55% |
| 1D | 5-15% | 2-8% | 40-65% | 30-55% |
| 1E | 4-10% | 2-8% | 40-65% | 30-55% |
| 1F | 0-10% | 0-6% | 50-60% | 35-45% |
| 1G | 3-8% | 2-5% | 50-60% | 35-45% |
| 1H | 0-8% | 0-5% | 45-55% | 45-55% |
| 1I | 3-8% | 2-5% | 45-55% | 45-55% |
| 1J | 0-20% | 0-10% | 20-55% | 40-75% |
| 1K | 5-15% | 2-8% | 20-55% | 40-75% |
| 1L | 4-10% | 2-6% | 20-55% | 40-75% |
| 1M | 0-15% | 0-10% | 20-45% | 50-75% |
| 1N | 4-10% | 2-8% | 20-45% | 50-75% |
| 1O | 0-10% | 0-10% | 20-35% | 60-75% |
| 1P | 2-8% | 2-6% | 20-35% | 60-75% |
| 1Q | 0-10% | 0-10% | 20-30% | 65-75% |
| 1R | 2-8% | 2-6% | 20-30% | 65-75% |

Additionally, certain blends that have a high level of stevioside produce unexpectedly low levels of bitterness. Broadly, an. REB-ABDS blend comprises, by weight, at least 5% yet no more than 20% Reb A, at least 20% yet no more than 70% Reb B, at least 5% yet no more than 20% Reb D, and/or at least 20% yet no more than 65% stevioside (based on the amount of Reb A, Reb B, Reb D and stevioside in the blend). In some embodiments, the REB-ABDS blend comprises at least 5% Reb A, at least 30% Reb B, at least 5% Reb D, and/or at least 25% stevioside (based on the amount of Reb A, Reb B, Reb D and stevioside in the blend). Alternately in some embodiments, the REB-ABDS blend comprises at least 5% Reb A, at least 35% Reb B, at least 5% Reb D, and/or at least 35% stevioside (based on the amount of Reb A, Reb B, Reb D and stevioside in the blend). In some embodiments, the REB-ABDS blend comprises no more than 15% Reb A, no more than 60% Reb B, no more than 15% Reb D, and/or no more than 45% stevioside (based on the amount of Reb A, Reb B, Reb D and stevioside in the blend). Alternately in some embodiments, the REB-ABDS blend comprises no more than 10% Reb A, no more than 55% Reb B, no more than 10% Reb D, and/or no more than 45% stevioside (based on the amount of Reb A, Reb B, Reb D and stevioside in the blend).

Surprisingly, these blends have a low level of bitterness, even with the high level of stevioside in the blend. In some embodiments, these blends provide an SEV of greater than 5 when present in a sweetener composition, in other embodiments these blends provide an SEV of greater than 6 when present in a sweetener composition, in still other embodiments these blends provide an SEV of greater than 7 when present in a sweetener composition, in still other embodiments these blends provide an SEV of greater than 8 when present in a sweetener composition, in still other embodiments these blends provide an SEV of greater than 9 when present in a sweetener composition, and in still other embodiments these blends provide an SEV of greater than 10 when present in a sweetener composition.

Specific examples of blends that have an unexpectedly low level of bitterness even with the high level of stevioside in the blend are provided in Table 2.

TABLE 2
High % stevioside, unexpected low bitterness

| Blend | Reb A | Reb B | Reb D | Stev |
|---|---|---|---|---|
| 2A | 5-20% | 20-70% | 5-20% | 20-65% |
| 2B | 5-15% | 30-55% | 5-15% | 40-65% |
| 2C | 5-10% | 35-45% | 5-10% | 55-65% |
| 2D | 5-15% | 50-70% | 5-15% | 25-45% |
| 2E | 5-10% | 50-60% | 5-10% | 35-45% |

Additionally, some blends that have a high level of stevioside unexpectedly produce high levels of sweetness and/or low levels of bitterness. In some embodiments, when these blends are in a sweetener composition, the combination of the Reb A and the stevioside is not greater than 50% or 60% of the glycoside blend. Broadly, an REB-ABDS blend comprises, by weight, at least 2% yet no more than 15% Reb A, at least 15% yet no more than 35% Reb B, at least 25% yet no more than 45% Reb D, and at least 30% yet no more than 50% stevioside (based on the amount of Reb A, Reb B, Reb D and stevioside in the blend). In some embodiments, the REB-ABDS blend comprises at least 5% Reb A, at least 20% Reb B, at least 30% Reb D, and at least 35% stevioside (based on the amount of Reb A, Reb B, Reb D and stevioside in the blend). Alternately in some embodiments, the REB-ABDS blend comprises at least 5% Reb A, at least 22% Reb B, at least 32% Reb D, and/or at least 37% stevioside (based on the amount of Reb A, Reb B, Reb D and stevioside in the blend). In some embodiments, the REB-ABDS blend comprises no more than 10% Reb A, no more than 30% Reb B, no more than 40% Reb D, and/or no more than 45% stevioside (based on the amount of Reb A, Reb B, Reb D and stevioside in the blend). Alternately in some embodiments, the REB-ABDS blend comprises no more than 7% Reb A, no more than 27% Reb B, no more than 37% Reb D, and/or no more than 42% stevioside (based on the amount of Reb A, Reb B, Reb D and stevioside in the blend).

Surprisingly, these blends have a high level of sweetness and/or a low level of bitterness, even with the high level of stevioside in the blend. In some embodiments, these blends provide an SEV of greater than 5 when present in a sweetener composition, in other embodiments these blends provide an SEV of greater than 6 when present in a sweetener composition, in still other embodiments these blends provide an SEV of greater than 7 when present in a sweetener composition, in still other embodiments these blends provide an SEV of greater than 8 when present in a sweetener composition, in still other embodiments these blends provide an SEV of greater than 9 when present in a sweetener composition, and in still other embodiments these blends provide an SEV of greater than 10 when present in a sweetener composition.

Specific examples of blends that have an unexpectedly high level of sweetness and/or an unexpectedly low level of bitterness even with the high level of stevioside in the blend are provided in Table 3.

TABLE 3
High % stevioside, unexpected sweetness
and/or unexpected low bitterness

| Blend | Reb A | Reb B | Reb D | Stev |
|---|---|---|---|---|
| 3A | 0-30% | 10-40% | 20-50% | 25-55% |
| 3B | 0-20% | 15-35% | 25-45% | 30-50% |
| 3C | 5-15% | 15-35% | 25-45% | 30-50% |
| 3D | 0-10% | 20-30% | 30-40% | 35-45% |
| 3E | 5-10% | 20-30% | 30-40% | 35-45% |
| 3F | 2-7% | 22-27% | 32-37% | 37-42% |

Still additional blends that have a high level of stevioside unexpectedly produce high levels of sweetness and/or low levels of bitterness. In these embodiments, the level of Reb A and the stevioside is not greater than 60% of the blend. Broadly, an REB-ABDS blend comprises, by weight, Reb A, at least 2% yet no more than 40% Reb B, at least 20% yet no more than 50% Reb D, and at least 25% yet no more than 55% stevioside (based on the amount of Reb A, Reb B, Reb D and stevioside in the blend). In some embodiments, the REB-ABDS blend comprises Reb A, at least 2% Reb B, at least 25% Reb D, and at least 30% stevioside (based on the amount of Reb A, Reb B, Reb D and stevioside in the blend). Alternately in some embodiments, the REB-ABDS blend comprises Reb A, at least 5% Reb B, at least 30% Reb D, and/or at least 35% stevioside (based on the amount of Reb A, Reb B, Reb D and stevioside in the blend). In some embodiments, the REB-ABDS blend comprises Reb A, no more than 35% Reb B, no more than 45% Reb D, and/or no more than 50% stevioside (based on the amount of Reb A, Reb B, Reb D and stevioside in the blend). Alternately in some embodiments, the REB-ABDS blend comprises Reb A, no more than 30% Reb B, no more than 40% Reb D, and/or no more than 45% stevioside (based on the amount of Reb A, Reb B, Reb D and stevioside in the blend).

Surprisingly, these blends have a high level of sweetness and/or a low level of bitterness, even with the high level of stevioside in the blend. In some embodiments, these blends provide an SEV of greater than 5 when present in a sweetener composition, in other embodiments these blends provide an SEV of greater than 6 when present in a sweetener composition, in still other embodiments these blends provide an SEV of greater than 7 when present in a sweetener composition, in still other embodiments these blends provide an SEV of greater than 8 when present in a sweetener composition, in still other embodiments these blends provide an SEV of greater than 9 when present in a sweetener composition, and in still other embodiments these blends provide an SEV of greater than 10 when present in a sweetener composition.

Specific examples of blends that have an unexpectedly high level of sweetness and/or an unexpectedly low level of bitterness even with the high level of stevioside in the blend are provided in Table 4. In some embodiments, the level of Reb A and the stevioside in these blends is not greater than 60% of the blend. In other embodiments, the level of Reb A and the stevioside in these blends is not greater than 50% of the blend.

TABLE 4
High % stevioside, unexpected sweetness
and/or unexpected low bitterness

| Blend | Reb B | Reb D | Stev |
|---|---|---|---|
| 4A | 10-40% | 20-50% | 25-55% |
| 4B | 15-35% | 25-45% | 30-50% |
| 4C | 20-30% | 30-40% | 35-45% |
| 4D | 22-27% | 32-37% | 37-42% |

Table 5 provides yet additional REB-ABDS blends that produce an unexpectedly high level of sweetness and/or unexpectedly low level of bitterness. In some embodiments, these blends provide an SEV of greater than 5 when present in a sweetener composition, in other embodiments these blends provide an SEV of greater than 6 when present in a sweetener composition, in still other embodiments these blends provide an SEV of greater than 7 when present in a sweetener composition, in still other embodiments these blends provide an SEV of greater than 8 when present in a sweetener composition, in still other embodiments these blends provide an SEV of greater than 9 when present in a sweetener composition, and in still other embodiments these blends provide an SEV of greater than 10 when present in a sweetener composition.

TABLE 5
Additional Blends with Stevioside

| Blend | Reb A | Reb B | Reb D | Stev |
|---|---|---|---|---|
| 5A | 25-45% | 25-45% | 5-25% | 5-25% |
| 5B | 35-45% | 35-45% | 5-15% | 5-15% |
| 5C | 37-43% | 37-43% | 7-13% | 7-13% |
| 5D | 25-35% | 25-35% | 15-25% | 15-25% |
| 5E | 27-33% | 27-33% | 17-23% | 17-23% |
| 5F | 25-35% | 35-50% | 3-5% | 25-35% |
| 5G | 10-25% | 50-75% | 3-5% | 5-25% |

Some preferred REB-ABDS blends comprise, by weight, at least 25% yet no more than 45% Reb A, at least 25% yet no more than 45% Reb B, at least 5% yet no more than 25% Reb D, and at least 5% yet no more than 25% stevioside (based on the amount of Reb A, Reb B, Reb D and stevioside in the blend). One such exemplary blend comprises 30% Reb A, 30% Reb B, 20% Reb D, and 20% stevioside. Another exemplary blend comprises 35% Reb A, 35% Reb B, 15% Reb D, and 15% stevioside. Yet another exemplary blend comprises 40% Reb A, 40% Reb B, 10% Reb D, and 10% stevioside.

Other preferred REB-ABDS blends comprise, by weight, at least 5% yet no more than 50% Reb A, at least 5% yet no more than 50% Reb B, at least 5% yet no more than 75% Reb D, and at least 5% yet no more than 40% stevioside (based on the amount of Reb A, Reb B, Reb D and stevioside in the blend). One such exemplary blend comprises 10-50% Reb A, 10-40% Reb B, 10-60% Reb D, and 10-30% stevioside.

Table 6 provides yet additional REB-ABDS blends. The benefits provided by these REB-ABDS blends can be any of the benefits described herein. But in particular, these blends can provide a more pleasing or enjoyable taste compared to Reb A.

TABLE 6
Additional REB-ABDS blends

| Blend | Reb A + Reb B | Reb D | Stev |
|---|---|---|---|
| 6A | 5-50% | 40-90% | 2-25% |
| 6B | 5-20% | 70-90% | 4-10% |
| 6C | 8-17% | 75-85% | 5-9% |
| 6D | 5-55% | 40-70% | 2-25% |
| 6E | 20-50% | 45-65% | 5-25% |
| 6F | 20-30% | 50-60% | 15-25% |
| 6G | 20-30% | 52-57% | 15-25% |
| 6H | 35-45% | 50-60% | 4-8% |
| 6I | 35-45% | 52-57% | 4-8% |
| 6J | 35-55% | 40-50% | 5-15% |
| 6K | 40-50% | 42-47% | 5-15% |
| 6L | 15-35% | 60-70% | 2-12% |
| 6M | 20-30% | 62-67% | 4-8% |

Table 7 provides yet additional REB-ABDS blends. The benefits provided by these REB-ABDS blends can be any of the benefits described herein. But in particular, these blends can provide a more pleasing or enjoyable taste compared to Reb A.

TABLE 7
Additional REB-ABDS Blends

| Blend | Reb A | Reb B | Reb D | Stev |
|---|---|---|---|---|
| 7A | 27-40% | 10-25% | 10-20% | 27-40% |
| 7B | 30-40% | 10-25% | 10-20% | 30-40% |
| 7C | 27-33% | 20-25% | 15-20% | 27-33% |

In some embodiments, the blends of this disclosure, which include any or all of Reb A, Reb B, and Reb D with stevioside, have an onset of sweetness that is faster than that of high purity (i.e., at least 60% pure, in some embodiments at least 80%, in other embodiments at least 90%, in yet other embodiments, at least 95%) Reb A. Additionally or alternately, in some embodiments, the blends of this disclosure have a sweet aftertaste that lingers longer than that of high purity Reb A. Additionally or alternately, in some embodiments, the blends of this disclosure have a bitterness aftertaste that lingers shorter than that of high purity Reb A. Additionally or alternately, in some embodiments, the blends of this disclosure have a bitterness aftertaste that is less strong than that of high purity Reb A. Additionally or alternately, in some embodiments, the blends of this disclosure have a taste that is more enjoyable or pleasing than high purity Reb A.

Sweetener Compositions with Glycoside Blends

As indicated above, the certain blends of stevioside combined with Reb A, Reb B and/or Reb D result in blends having a have higher sweetening ability than Reb A. Thus, the utilization of these blends in a sweetener composition could result in significant cost savings.

The sweetener compositions can also include other ingredients in addition to the glycoside blend. In some embodiments, the sweetener composition can include one or more of bulking agent(s), a high-intensity sweetener(s), flavoring(s), an antioxidant, caffeine, other nutritive sweetener(s), salt(s), protein, bitter blocker or a sweetness enhancer.

A bulking agent can include any compositions known in the art used to add bulk to high intensity sweeteners. Bulking agents are often used with high intensity sweeteners, such as the glycoside blends of this disclosure, to facilitate a direct substitution of sweeteners of this disclosure for other sweeteners, such as sugar, in applications such as baking, cooking, and tabletop uses. A bulking agent may be chosen from a bulk sweetener, a lower glycemic carbohydrate, a fiber, a hydrocolloid, and combinations thereof. A bulk sweetener may be chosen from corn sweeteners, sucrose, dextrose, invert sugar, maltose, dextrin, maltodextrin, fructose, levulose, high fructose corn syrup, corn syrup solids, galactose, trehalose, isomaltulose, fructo-oligosaccharides, and combinations thereof. A lower glycemic carbohydrate may be chosen from fructo-oligosaccharide, galactooligosaccharide, isomaltooligosaccharide, oligodextran, D-tagatose, sorbitol, mannitol, xylitol, lactitol, erythritol, maltitol, other polyols, hydrogenated starch hydrolysates, isomalt, D-psicose, 1,5 anhydro D-fructose, and combinations thereof.

A fiber may be chosen from polydextrose, resistant maltodextrin, resistant starch, inulin, soluble corn fiber, beta-glucan, psyllium, cellulose, hemicellulose, and combinations thereof. A hydrocolloid may be chosen from pectin (e.g., apple, beet, citrus), gum Arabic, guar gum, carboxymethylcellulose, nOSA (n-octenyl succinic anhydride), locust bean gum, cassia gum, xanthan gum, carrageenan, alginate, and combinations thereof.

A high intensity sweetener may be chosen from sucralose, aspartame, saccharin, acesulfame K, alitame, thaumatin, dihydrochalcones, neotame, cyclamates, mogroside, glycyrrhizin, phyllodulcin, monellin, mabinlin, brazzein, circulin, pentadin, monatin, and combinations thereof. A flavoring may be chosen from a cola flavor, a citrus flavor, a root beer flavor, and combinations thereof. A sweetness enhancer may be chosen from curculin, miraculin, cynarin, chlorogenic acid, caffeic acid, strogins, arabinogalactan, maltol, dihyroxybenzoic acids, and combinations thereof.

Other ingredients such as food starch, flours, protein isolates, protein concentrates, food fats and oils (such as cocoa butter), emulsifiers, food extracts (such as malt extract), and juice concentrates may also be included in the sweetener compositions.

In some particular embodiments, the sweetener composition can also include a lower glycemic carbohydrate. In certain embodiments, the lower glycemic carbohydrate is erythritol or another polyol.

### Food and Beverage Compositions

The sweetener compositions of the present disclosure can be incorporated into food and beverage compositions. Thus, the present disclosure also contemplates food compositions and beverage compositions that include the sweetener compositions of the present disclosure.

Examples of food compositions include baked goods, soups, sauces, processed meats canned fruits, canned vegetables, dairy products, frozen confections, confections, chewing gums, cakes, cookies, bars, and other sweet bakery items, cereals, cereal bars, yogurt, energy bars, granola bars, hard candy, jelly candy, chocolate candy, and other sweet confections. Examples of beverages include carbonated soft drinks, powdered soft drinks, ready to drink teas, sports drinks, dairy drinks, yogurt-containing drinks, alcoholic beverages, energy drinks, flavored waters, vitamin drinks, fruit drinks, and fruit juices.

Examples of other edible compositions into which the sweetener compositions of this disclosure can be used include oral care products such as toothpastes, mouthwashes, and oral rinses; pharmaceutical products such as tablets, capsules, lozenges, and suspensions; and nutraceutical products such as supplements, vitamins, probiotics and prebiotics.

Non-edible products, but those that may be considered as food products, to which the sweetener compositions of this disclosure can be added include tobacco products such as pipe tobacco, snuff and chewing tobacco.

### Methods of Producing Blends and Sweetener Compositions

The present disclosure also contemplates methods for producing the glycoside blends and the sweetener compositions. Typical conventional stevia based sweeteners include a glycoside blend which consists primarily of Reb A (for example greater than 80% Reb A, greater than 95% Reb A, or greater than 97% Reb A). The present disclosure contemplates adding Reb B and stevioside and optionally Reb D to such conventional sweeteners. In some embodiments, any of Reb B, Reb D and stevioside could be added to such sweeteners to achieve the desired glycoside blend ratios.

The present disclosure also contemplates controlled conversion between one glycoside and another glycoside to achieve the glycoside blends of the present disclosure. Thus, in one embodiment, a substantially pure Reb A composition can be converted to particular REB-ABS blend or REB-ABDS blend at the disclosed ratios.

### EXAMPLES

### Example 1

### Sensory Testing of Various Glycoside Blends

A quantitative descriptive analysis (QDA) panel was used to evaluate the intensity of sweetness and other sensory attributes related to stevia based sweeteners of commercially available stevia products and various steviol glycoside blends. The seven panelists were highly trained and experienced on-call taste panelists. Immediately prior to this testing, the panelists had four training sessions with practice samples. They practiced scoring the samples using a scale of 0 to 15 with 0 being “none” and 15 being “strong”.

The panelists evaluated eight (8) samples of pure and blended solutions of Reb A, Reb B, Reb D and stevioside at ratios and concentrations (parts per million) shown in Table 8 below. Panelists tasted 1.5 liquid ounces of the sample from a 2 ounce cup. The panelists' responses were measured, compiled, and averaged for each sample.

TABLE 8
Composition of Samples 1-8

| Sample | Blend | Ppm |
|---|---|---|
| 1 | Truvia ® stevia leaf extract (83.0% Reb A) | 463 |
| 2 | Truvia ® stevia leaf extract (52.4% Reb A) | 488 |
| 3 | Reb A/Reb B/Reb D - 30/40/30 | 464 |
| 4 | Reb A/Reb B/Stevioside - 50/10/40 | 467 |
| 5 | Reb A/Reb B/Reb D/Stevioside - 20/10/60/10 | 348 |
| 6 | Reb A/Reb B/Reb D/Stevioside - 20/40/20/20 | 390 |
| 7 | Reb A/Reb B/Reb D/Stevioside - 40/40/10/10 | 412 |
| 8 | Reb A/Reb B/Reb D/Stevioside - 30/30/20/20 | 383 |

The ingredients used for the blends above (Samples 3-8) were: Reb A having a purity of 96.7%; Reb B having a purity of 97.3%; Reb D having a purity of 85.4%; and stevioside having a purity of 98.3%.

The following results are presented in the order of tasting of the samples.

TABLE 9
Mean Scores for Sweetness

| | | Time to | | | | |
|---|---|---|---|---|---|---|
| | | max | | 30 second | 60 second | 90 second |
| Sample | Blend | sweetness | Sweetness | aftertaste | aftertaste | aftertaste |
| 8 | A/B/D/S - 30/30/20/20 | 1.57 | 6.41 | 2.70 | 1.21 | 0.41 |
| 7 | A/B/D/S - 40/40/10/10 | 1.19 | 6.09 | 2.42 | 1.09 | 0.32 |
| 5 | A/B/D/S - 20/10/60/10 | 1.56 | 6.20 | 2.61 | 0.74 | 0.18 |
| 4 | A/B/S - 50/10/40 | 1.53 | 6.64 | 3.01 | 1.64 | 0.50 |
| 6 | A/B/D/S - 20/40/20/20 | 1.94 | 6.19 | 2.58 | 1.07 | 0.25 |
| 3 | A/B/D - 30/40/30 | 2.11 | 6.91 | 3.09 | 1.39 | 0.51 |
| 1 | Reb A (83.0%) | 1.64 | 6.62 | 3.17 | 1.60 | 0.68 |
| 2 | Reb A (52.4%) | 1.63 | 6.38 | 2.99 | 1.19 | 0.44 |

TABLE 10
Mean Scores for Herbal and Bitter Taste

| | | | 30 second | | 30 second | 60 second | 90 second |
|---|---|---|---|---|---|---|---|
| | | Herbal | herbal | | bitter | bitter | bitter |
| | Blend | Flavor | aftertaste | Bitter | aftertaste | aftertaste | aftertaste |
| 8 | A/B/D/S - 30/30/20/20 | 0.78 | 0.50 | 0.94 | 0.89 | 0.49 | 0.18 |
| 7 | A/B/D/S - 40/40/10/10 | 0.82 | 0.55 | 1.19 | 0.93 | 0.54 | 0.38 |
| 5 | A/B/D/S - 20/10/60/10 | 0.84 | 0.49 | 1.29 | 1.03 | 0.72 | 0.24 |
| 4 | A/B/S - 50/10/40 | 0.96 | 0.74 | 1.09 | 1.01 | 0.49 | 0.04 |
| 6 | A/B/D/S - 20/40/20/20 | 1.30 | 0.70 | 1.39 | 1.04 | 0.74 | 0.13 |
| 3 | A/B/D - 30/40/30 | 0.96 | 0.77 | 1.19 | 0.92 | 0.38 | 0.19 |
| 1 | Reb A (83.0%) | 1.53 | 0.79 | 1.64 | 1.24 | 0.71 | 0.35 |
| 2 | Reb A (52.4%) | 1.44 | 1.18 | 1.94 | 1.63 | 1.18 | 0.64 |

TABLE 11
Mean Scores for Non-Sucrose Flavors

| | | | 30 second | 60 second | 90 second | Drying |
|---|---|---|---|---|---|---|
| | | Non- | non- | non- | non- | astringent |
| | | sucrose | sucrose | sucrose | sucrose | after 90 |
| Sample | Blend | flavors | aftertaste | aftertaste | aftertaste | seconds |
| 8 | A/B/D/S - 30/30/20/20 | 1.75 | 1.72 | 1.42 | 0.73 | 3.34 |
| 7 | A/B/D/S - 40/40/10/10 | 1.90 | 1.84 | 1.29 | 0.89 | 3.12 |
| 5 | A/B/D/S - 20/10/60/10 | 1.95 | 1.91 | 1.51 | 1.06 | 3.29 |
| 4 | A/B/S - 50/10/40 | 2.26 | 1.95 | 1.49 | 0.95 | 3.13 |
| 6 | A/B/D/S - 20/40/20/20 | 2.34 | 1.94 | 1.29 | 0.94 | 3.36 |
| 3 | A/B/D - 30/40/30 | 2.41 | 2.11 | 1.61 | 0.96 | 3.21 |
| 1 | Reb A (83.0%) | 2.89 | 2.33 | 1.84 | 1.21 | 3.57 |
| 2 | Reb A (52.4%) | 3.05 | 2.43 | 1.75 | 1.13 | 3.48 |

### Example 2

### Additional Sensory Testing of Various Glycoside Blends

Various 4-way glycoside blends were evaluated relative to a highly pure rebaudioside A composition (approximately 95% pure rebaudioside A), referred to as RA95. Blends were prepared by mixing highly pure rebaudioside A, rebaudioside B, rebaudioside D, and stevioside at ratios as listed in table 12 below. Samples were prepared at 600 ppm in water. Panelists blind tasted each blend in comparison to an RA95 control sample. Approximately half of the panel tasted the RA95 sample first, and the other half tasted the blend sample first. Panelists scored each sample using a scale of 1 to 10 based on how much they enjoyed the taste of that sample, a score of 1 being “terrible”, and a score of 10 being “excellent”. The liking scores were then averaged and are shown in table 12 below. Panelists also indicated whether they preferred the taste of the blend over the taste of RA95. The number of panelists who preferred the blend over RA95 is also listed in table 12 below.

TABLE 12

| | | | | | Conc | | Liking | Liking |
|---|---|---|---|---|---|---|---|---|
| Blend | Stev | Reb A | Reb B | Reb D | (ppm) | Preferred | (blend) | (RA95 control) |
| 1 | 5.00% | 20.00% | 20.00% | 55.00% | 600 | 5 out of 5 | 9.2 | 6.2 |
| 2 | 5.00% | 5.00% | 5.00% | 85.00% | 600 | 4 out of 4 | 8.7 | 4.0 |
| 3 | 8.33% | 8.33% | 8.33% | 75.00% | 600 | 3 out of 3 | 8.7 | 6.0 |
| 4 | 5.00% | 45.00% | 5.00% | 45.00% | 600 | 6 out of 6 | 8.4 | 5.5 |
| 5 | 5.00% | 5.00% | 25.00% | 65.00% | 600 | 5 out of 5 | 8.0 | 4.4 |
| 6 | 15.00% | 25.00% | 25.00% | 35.00% | 600 | 4 out of 4 | 8.0 | 5.7 |
| 7 | 5.00% | 55.00% | 15.00% | 25.00% | 600 | 6 out of 6 | 8.0 | 5.0 |
| 8 | 11.67% | 11.67% | 11.67% | 65.00% | 600 | 5 out of 6 | 7.8 | 6.0 |
| 9 | 15.00% | 15.00% | 15.00% | 55.00% | 600 | 3 out of 4 | 7.8 | 5.6 |
| 10 | 25.00% | 10.00% | 10.00% | 55.00% | 600 | 7 out of 7 | 7.6 | 4.6 |
| 11 | 15.00% | 5.00% | 25.00% | 55.00% | 600 | 4 out of 4 | 7.5 | 4.7 |
| 12 | 5.00% | 5.00% | 55.00% | 35.00% | 600 | 6 out of 7 | 7.4 | 5.0 |
| 13 | 5.00% | 35.00% | 5.00% | 55.00% | 600 | 5 out of 7 | 7.3 | 4.7 |
| 14 | 5.00% | 65.00% | 5.00% | 25.00% | 600 | 4 out of 6 | 7.3 | 6.0 |
| 15 | 30.00% | 30.00% | 25.00% | 15.00% | 600 | 6 out of 7 | 7.1 | 5.0 |
| 16 | 5.00% | 55.00% | 5.00% | 35.00% | 600 | 6 out of 7 | 6.9 | 4.8 |
| 17 | 5.00% | 5.00% | 35.00% | 55.00% | 600 | 4 out of 4 | 6.8 | 5.0 |
| 18 | 5.00% | 5.00% | 45.00% | 45.00% | 600 | 5 out of 5 | 6.8 | 5.3 |
| 19 | 5.00% | 25.00% | 33.00% | 37.00% | 600 | 4 out of 6 | 6.7 | 4.7 |
| 20 | 30.00% | 30.00% | 20.00% | 20.00% | 600 | 3 out of 6 | 6.7 | 6.0 |
| 21 | 25.00% | 45.00% | 5.00% | 25.00% | 600 | 4 out of 6 | 6.6 | 5.9 |
| 22 | 15.00% | 65.00% | 5.00% | 15.00% | 600 | 5 out of 6 | 6.6 | 5.2 |
| 23 | 15.00% | 35.00% | 5.00% | 45.00% | 600 | 5 out of 5 | 6.0 | 4.5 |
| 24 | 5.00% | 75.00% | 5.00% | 15.00% | 600 | 4 out of 6 | 5.7 | 4.5 |
| 25 | 40.00% | 40.00% | 10.00% | 10.00% | 600 | 3 out of 6 | 5.4 | 4.3 |

Panelists also indicated whether some of the blends were sweeter or less bitter than the RA95. These results are listed in table 13 below.

TABLE 13

| | | | | | More | Less |
|---|---|---|---|---|---|---|
| Blend | Stev | Reb A | Reb B | Reb D | Sweet | Bitter |
| 1 | 5.00% | 20.00% | 20.00% | 55.00% | | Y |
| 2 | 5.00% | 5.00% | 5.00% | 85.00% | | Y |
| 3 | 8.33% | 8.33% | 8.33% | 75.00% | | Y |
| 4 | 5.00% | 45.00% | 5.00% | 45.00% | | Y |
| 5 | 5.00% | 5.00% | 25.00% | 65.00% | Y | Y |
| 6 | 15.00% | 25.00% | 25.00% | 35.00% | | Y |
| 7 | 5.00% | 55.00% | 15.00% | 25.00% | | Y |
| 8 | 11.67% | 11.67% | 11.67% | 65.00% | | Y |
| 9 | 15.00% | 15.00% | 15.00% | 55.00% | | Y |
| 10 | 25.00% | 10.00% | 10.00% | 55.00% | | N |
| 11 | 15.00% | 5.00% | 25.00% | 55.00% | | Y |
| 12 | 5.00% | 5.00% | 55.00% | 35.00% | Y | Y |
| 13 | 5.00% | 35.00% | 5.00% | 55.00% | N | Y |
| 14 | 5.00% | 65.00% | 5.00% | 25.00% | N | Y |
| 15 | 30.00% | 30.00% | 25.00% | 15.00% | Y | Y |
| 16 | 5.00% | 55.00% | 5.00% | 35.00% | N | Y |
| 17 | 5.00% | 5.00% | 35.00% | 55.00% | N | Y |
| 18 | 5.00% | 5.00% | 45.00% | 45.00% | Y | Y |
| 19 | 5.00% | 25.00% | 33.00% | 37.00% | N | Y |
| 20 | 30.00% | 30.00% | 20.00% | 20.00% | | N |
| 21 | 25.00% | 45.00% | 5.00% | 25.00% | | N |
| 22 | 15.00% | 65.00% | 5.00% | 15.00% | N | Y |
| 23 | 15.00% | 35.00% | 5.00% | 45.00% | | Y |
| 24 | 5.00% | 75.00% | 5.00% | 15.00% | Y | Y |
| 25 | 40.00% | 40.00% | 10.00% | 10.00% | | N |

### Example 3

### Additional Sensory Testing of Three Glycoside Blends

Three additional blends were tested according to the procedure of example 2. The blends and liking scores are listed in table 14 below.

TABLE 14

| | | | | | Conc | Liking | Liking |
|---|---|---|---|---|---|---|---|
| Blend | Stev | Reb A | Reb B | Reb D | (ppm) | (blend) | (RA95 control) |
| 1 | 35.00% | 5.00% | 5.00% | 55.00% | 600 | 6.4 | 4.5 |
| 2 | 55.00% | 5.00% | 10.00% | 30.00% | 600 | 4.3 | 5.5 |
| 3 | 37.00% | 5.00% | 22.00% | 36.00% | 600 | 6.5 | 4.8 |

Thus, various embodiments of the glycoside blends are disclosed. The implementations described above and other implementations are within the scope of the following claims. One skilled in the art will appreciate that the present invention can be practiced with embodiments other than those disclosed. The disclosed embodiments are presented for purposes of illustration and not limitation, and the present invention is limited only by the claims that follow.

1. A glycoside blend comprising:
2% to 15% rebaudioside A,
2% to 8% rebaudioside B,
20% to 65% rebaudioside D, and
30% to 75% stevioside,
based on the amount of rebaudioside A, rebaudioside B, rebaudioside D and stevioside in the blend.

2. The glycoside blend according to claim 1 comprising:
3% to 8% rebaudioside A,
2% to 5% rebaudioside B,
50% to 60% rebaudioside D, and
35% to 45% stevioside,
based on the amount of rebaudioside A, rebaudioside B, rebaudioside D and stevioside in the blend.

3. A glycoside blend comprising:
27% to 40% rebaudioside A,
10% to 25% rebaudioside B,
10% to 20% rebaudioside D, and
27% to 40% stevioside,
based on the amount of rebaudioside A, rebaudioside B, rebaudioside D and stevioside in the blend.

4. The glycoside blend according to claim 3 comprising:
27% to 33% rebaudioside A,
20% to 25% rebaudioside B,
15% to 20% rebaudioside D, and
27% to 33% stevioside,
based on the amount of rebaudioside A, rebaudioside B, rebaudioside D and stevioside in the blend.

5. A glycoside blend comprising:
2% to 15% rebaudioside A,
15% to 35% rebaudioside B,
25% to 45% rebaudioside D, and
30% to 50% stevioside,
based on the amount of rebaudioside A, rebaudioside B, rebaudioside D and stevioside in the blend, wherein the amount of rebaudioside A and stevioside is no more than 60% of the amount of rebaudioside A, rebaudioside B, rebaudioside D and stevioside.

6. The glycoside blend of claim 5 wherein the amount of rebaudioside A and stevioside is no more than 50% of the blend.

7. The glycoside blend according to claim 5 comprising:
2% to 7% rebaudioside A,
22% to 27% rebaudioside B,
32% to 37% rebaudioside D, and
37% to 42% stevioside,
based on the amount of rebaudioside A, rebaudioside B, rebaudioside D and stevioside in the blend.

8. A glycoside blend comprising:
25% to 45% rebaudioside A,
25% to 45% rebaudioside B,
5% to 25% rebaudioside D, and
5% to 25% stevioside,
based on the amount of rebaudioside A, rebaudioside B, rebaudioside D and stevioside in the blend.

9. The glycoside blend according to claim 8 comprising:
30% to 40% rebaudioside A,
30% to 40% rebaudioside B,
10% to 20% rebaudioside D, and
10% to 20% stevioside,
based on the amount of rebaudioside A, rebaudioside B, rebaudioside D and stevioside in the blend.

10. The glycoside blend according to claim 8 comprising:
35% to 45% rebaudioside A,
35% to 45% rebaudioside B,
5% to 15% rebaudioside D, and
5% to 15% stevioside,
based on the amount of rebaudioside A, rebaudioside B, rebaudioside D and stevioside in the blend.

11. The glycoside blend according to claim 8 comprising:
37% to 43% rebaudioside A,
37% to 43% rebaudioside B,
7% to 13% rebaudioside D, and
7% to 13% stevioside,
based on the amount of rebaudioside A, rebaudioside B, rebaudioside D and stevioside in the blend.

12. The glycoside blend according to claim 8 comprising:
25% to 35% rebaudioside A,
25% to 35% rebaudioside B,
15% to 25% rebaudioside D, and
15% to 25% stevioside,
based on the amount of rebaudioside A, rebaudioside B, rebaudioside D and stevioside in the blend.

13. The glycoside blend according to claim 8 comprising:
27% to 33% rebaudioside A,
27% to 33% rebaudioside B,
17% to 23% rebaudioside D, and
17% to 23% stevioside,
based on the amount of rebaudioside A, rebaudioside B, rebaudioside D and stevioside in the blend.

14. A glycoside blend comprising:
70% to 90% rebaudioside D, and
4% to 10% stevioside,
based on the amount of rebaudioside A, rebaudioside B, rebaudioside D and stevioside in the blend, wherein the combined amount of rebaudioside A and rebaudioside B comprises from 5% to 20% based on the amount of rebaudioside A, rebaudioside B, rebaudioside D and stevioside in the blend.

15. A glycoside blend comprising:
40% to 70% rebaudioside D, and
2% to 25% stevioside,
based on the amount of rebaudioside A, rebaudioside B, rebaudioside D and stevioside in the blend, wherein the combined amount of rebaudioside A and rebaudioside B comprises from 5% to 55% based on the amount of rebaudioside A, rebaudioside B, rebaudioside D and stevioside in the blend.

16. The glycoside blend according to claim 15 comprising:
42% to 47% rebaudioside D, and
5% to 15% stevioside,
based on the amount of rebaudioside A, rebaudioside B, rebaudioside D and stevioside in the blend, wherein the combined amount of rebaudioside A and rebaudioside B comprises from 40% to 50% based on the amount of rebaudioside A, rebaudioside B, rebaudioside D and stevioside in the blend.

17. The glycoside blend according to claim 15 comprising:
52% to 57% rebaudioside D, and
4% to 8% stevioside,
based on the amount of rebaudioside A, rebaudioside B, rebaudioside D and stevioside in the blend, wherein the combined amount of rebaudioside A and rebaudioside B comprises from 35% to 45% based on the amount of rebaudioside A, rebaudioside B, rebaudioside D and stevioside in the blend.

18. The glycoside blend according to claim 15 comprising:
52% to 57% rebaudioside D, and
15% to 25% stevioside,
based on the amount of rebaudioside A, rebaudioside B, rebaudioside D and stevioside in the blend, wherein the combined amount of rebaudioside A and rebaudioside B comprises from 20% to 30% based on the amount of rebaudioside A, rebaudioside B, rebaudioside D and stevioside in the blend.

19. The glycoside blend according to claim 15 comprising:
62% to 67% rebaudioside D, and
4% to 8% stevioside,
based on the amount of rebaudioside A, rebaudioside B, rebaudioside D and stevioside in the blend, wherein the combined amount of rebaudioside A and rebaudioside B comprises from 20% to 30% based on the amount of rebaudioside A, rebaudioside B, rebaudioside D and stevioside in the blend.

20. The glycoside blend of any of claims 1-19 wherein the glycoside blend provides an SEV of greater than 7.

21. A sweetener composition comprising:
the glycoside blend of any of claims 1-20; and
a bulking agent.
